(19) United States
(12) Patent Application Publication
(10) Pub. No.: US 2007/0058715 A1
(43) Pub. Date: Mar. 15, 2007

(54) Apparatus and method for image encoding and decoding and recording medium having recorded thereon a program for performing the method

(75) Inventors: So-young Kim, Yongin-si (KR); Jeong-hoon Park, Seoul (KR); Sang-rae Lee, Suwon-si (KR); Yu-mi Sohn, Seongnam-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/509,556

(22) Filed: Aug. 25, 2006

(30) Foreign Application Priority Data
Sep. 9, 2005 (KR) 10-2005-0084240

(51) Int. Cl. H04N 11/04; H04B 1/66

(52) U.S. Cl. 375/240.03; 375/240.1

(57) ABSTRACT

An intraprediction encoding and decoding apparatus and method, and a recording medium having recorded thereon a program for performing the methods are provided. The image encoding method includes dividing an input image into at least two sub-planes; performing transformation and quantization on the sub-planes; performing intraprediction encoding on at least one of the transformed and quantized sub-planes; and performing interprediction encoding on at least one remaining transformed and quantized sub-plane that has not been intraprediction encoded by using the at least one intraprediction encoded sub-plane as a reference sub-plane. The decoding method includes receiving an encoded bitstream; entropy decoding the received bitstream; performing intraprediction decoding on at least one intraprediction encoded sub-plane included in the entropy decoded image data; performing interprediction decoding on at least one remaining sub-plane included in the entropy encoded image data using the intraprediction decoded sub-plane as a reference sub-plane; and performing inverse quantization and inverse transformation on the decoded sub-planes.

### CROSS-REFERENCE TO RELATED APPLICATION

This application claims priority from Korean Patent Application No. 10-2005-0084240, filed on Sep. 9, 2005, in the Korean Intellectual Property Office, the disclosure of which is incorporated herein in its entirety by reference.

### BACKGROUND OF THE INVENTION

1. Field of the Invention

The present invention relates to image compression encoding, and more particularly, to an image prediction method which improves compression efficiency, and an apparatus and method for image encoding and decoding using the image prediction method.

2. Description of the Related Art

In well-known image compression standards such as the Moving Picture Expert Group (MPEG)-1, MPEG-2, MPEG-4 Visual, H.261, H.263, and H.264 standards, a picture is generally divided into macroblocks for image encoding. In the case of H.264 encoders, after each of the macroblocks is encoded in all interprediction and intraprediction encoding modes available, bit rates required for encoding the macroblock and rate-distortion (RD) costs in the various encoding modes are compared. Then an appropriate encoding mode is selected according to the result of the comparison and the macroblock is encoded in the selected encoding mode.

In intraprediction, instead of referring to reference pictures, a prediction value of a macroblock to be encoded is calculated using a pixel value of a pixel that is spatially adjacent to the macroblock to be encoded and a difference between the prediction value and the pixel value is encoded when encoding macroblocks of a current picture.

FIG. 1 illustrates the use of previous macroblocks for the intraprediction of a current macroblock a₅ according to a conventional art.

Referring to FIG. 1, previous macroblocks a₁, a₂, a₃, and a₄ are used for the intraprediction of the current macroblock a₅. According to a raster scan scheme, macroblocks included in a picture are scanned left-to-right and top-to-bottom. Thus, the previous macroblocks a₁, a₂, a₃, and a₄ are scanned and encoded before the current macroblock a₅.

Because macroblocks marked with X in FIG. 1 are not encoded, they cannot be used for predictive encoding of the current macroblock a₅. The macroblock marked with O in FIG. 1 has a low correlation with the current macroblock a₅. Macroblocks having low correlation with the current macroblock a₅ are also not used for predictive encoding of the current macroblock a₅. After transformation using a discrete cosine transform (DCT) and quantization, the previous macroblocks a₁, a₂, a₃, and a₄ are inverse quantized and the inverse DCT is taken and then the previous macroblocks are reconstructed.

FIG. 2 is a reference diagram for explaining adjacent pixels used in intra 4×4 modes of the H.264 standard according to a conventional art.

Referring to FIG. 2, lower-case letters a through p indicate pixels of a 4×4 block to be predicted, and upper-case letters A through M located above and to the left of the 4×4 block indicate neighboring samples or pixels required for intraprediction of the 4×4 block which have already been encoded and reconstructed.

FIG. 3 illustrates intra 4×4 modes used in the H.264 standard according to a conventional art.

Referring to FIG. 3, there are 9 intra 4×4 modes, i.e., a vertical mode 0, a horizontal mode 1, a direct current (DC) mode 2, a diagonal down-left mode 3, a diagonal down-right mode 4, a vertical-right mode 5, a horizontal-down mode 6, a vertical-left mode 7, a horizontal-up mode 8. Using the intra 4×4 modes, pixel values of the pixels a through p as shown in FIG. 2 are predicted from the pixels A through M of adjacent macroblocks. Compression efficiency varies according to an encoding mode selected for intraprediction. To select the optimal encoding mode, a block is predicted in every encoding mode, costs are calculated for each of the modes using a predetermined cost function, and an encoding mode having the smallest cost is selected for encoding.

However, there is a still a need for an encoding method capable of improving compression efficiency to provide high-quality images to users.

### SUMMARY OF THE INVENTION

According to an aspect of the present invention, there is provided an image encoding method including dividing an input image into at least two sub-planes, performing transformation and quantization on the divided at least two sub-planes, performing intraprediction encoding on at least one of the transformed and quantized sub-planes, and performing interprediction encoding on at least one remaining transformed and quantized sub-plane that has not been intraprediction encoded by using the at least one intraprediction encoded sub-plane as a reference sub-plane.

The interprediction encoding may be performed on a block of the at least one the remaining transformed and quantized sub-plane that has not been interprediction encoded using a corresponding block of the at least one intraprediction encoded sub-plane as a reference block.

The interprediction encoding may be performed by obtaining a difference between the reference block and the block.

The interprediction encoding may be performed on only a pattern of components of the block.

The interprediction encoding may be performed only on a low-frequency component of the block.

The predetermined block may be an 8×8 block and the interprediction encoding may be performed only on a 4×4 low-frequency component of the block.

The image encoding method may further include determining the spatial characteristic of the input image, wherein the interprediction encoding may be performed on the entire block or a portion of the block according to the determined spatial characteristics of the input image.

The dividing of the input image may include sub-sampling the input image.

The image encoding method may further include generating mode information including at least one of a size of each sub-plane, a number of sub-planes, and information about prediction.

According to another aspect of the present invention, there is provided an image encoder including an image division unit, a transformation and quantization unit, an intraprediction encoding unit, and an interprediction encoding unit. The image division unit divides an input image into at least two sub-planes. The transformation and quantization unit performs transformation and quantization on the at least two sub-planes. The intraprediction encoding unit performs intraprediction encoding on at least one of the transformed and quantized sub-planes. The interprediction encoding unit performs interprediction encoding on at least one remaining transformed and quantized sub-plane that has not been intraprediction encoded by using the at least one intraprediction encoded sub-plane as a reference sub-plane.

According to still another aspect of the present invention, there is provided an image decoding method including receiving an encoded bitstream, entropy decoding the received bitstream, performing intraprediction decoding on at least one intraprediction encoded sub-plane included in the entropy decoded image data, performing interprediction decoding on at least one remaining sub-plane included in the entropy encoded image data using the at least one intraprediction decoded sub-plane as a reference sub-plane, and performing inverse quantization and inverse transformation on the intraprediction decoded and interprediction decoded sub-planes.

The image decoding method may further include reconstructing the input image by re-arranging the intraprediction decoded and interprediction decoded sub-planes.

The interprediction decoding may be performed on a block of the at least one remaining sub-plane using a corresponding block of the at least one intraprediction decoded sub-plane, as a reference block.

The interprediction decoding may be performed by adding coefficients of the reference block and coefficients of the block.

The interprediction decoding may be performed on only a pattern of components of the block.

The interprediction decoding may be performed on only a low-frequency component of the block.

The predetermined block may be an 8×8 block and the interprediction decoding may be performed on only a 4×4 low-frequency component of the block.

The image decoding method further includes further extracting mode information from the bitstream, wherein the mode information includes at least one of a size of each of the sub-planes, a number of sub-planes, information about intraprediction, and information about interprediction.

According to yet another aspect of the present invention, there is provided an image decoder including an entropy decoding unit, an intraprediction decoding unit, an interprediction decoding unit, and an inverse quantization and inverse transformation unit. The entropy decoding unit receives an encoded bitstream, and performs entropy decoding on the received bitstream. The intraprediction decoding unit performs intraprediction decoding on at least one intraprediction encoded sub-plane included in the entropy decoded image data. The interprediction decoding unit performs interprediction decoding on at least one remaining sub-plane included in the entropy decoded image data using the at least one intraprediction decoded sub-plane as a reference sub-plane. The inverse quantization and inverse transformation unit performs inverse quantization and inverse transformation on the intraprediction decoded and interprediction decoded sub-planes.

According to yet another aspect of the present invention, there is provided a computer-readable recording medium having recorded thereon a program for performing an image encoding method. The image encoding method includes dividing an input image into at least two sub-planes, performing transformation and quantization on the at least two sub-planes, performing intraprediction encoding on at least one of the transformed and quantized sub-planes, and performing interprediction encoding on at least one remaining transformed and quantized sub-plane that has not been intraprediction encoded by using the at least one intraprediction encoded sub-plane as a reference sub-plane.

According to yet another aspect of the present invention, there is provided a computer-readable recording medium having recorded thereon a program for performing an image decoding method. The image decoding method includes receiving an encoded bitstream, entropy decoding the received bitstream, performing intraprediction decoding on at least one intraprediction encoded sub-plane included in the entropy decoded image data, performing interprediction decoding on at least one remaining sub-plane included in the entropy encoded image data using the at least one intraprediction decoded sub-plane as a reference sub-plane, and performing inverse quantization and inverse transformation on the intraprediction decoded and interprediction decoded sub-planes.

### BRIEF DESCRIPTION OF THE DRAWINGS

The above and other aspects of the present invention will become more apparent by describing in detail exemplary embodiments thereof with reference to the attached drawings in which:

FIG. 1 illustrates previous macroblocks used for the intraprediction of a current macroblock according to a conventional art;

FIG. 2 is a reference diagram for explaining adjacent pixels used in intra 4×4 modes of the H.264 standard according to a conventional art;

FIG. 3 illustrates intra 4×4 modes used in the H.264 standard according to a conventional art;

FIG. 4 is a block diagram of an image encoder according to an exemplary embodiment of the present invention;

FIGS. 5A through 5C are views for explaining examples of sub-plane types divided according to an exemplary embodiment of the present invention;

FIG. 6 illustrates four sub-planes divided from a picture according to an exemplary embodiment of the present invention;

FIG. 7 illustrates coefficients obtained through transformation and quantization with respect to the four sub-planes of FIG. 6;

FIGS. 8A through 8D are views for explaining interprediction methods according to an exemplary embodiment of the present invention;

FIG. 9 is a flowchart illustrating an image encoding method implemented by the image encoder of FIG. 4;

FIGS. 10A and 10B illustrate examples of a scanning method applied to an exemplary embodiment of the present invention;

FIG. 11 is a block diagram of an image decoder according to an exemplary embodiment of the present invention; and

FIG. 12 is a flowchart illustrating an image decoding method implemented by the image decoder of FIG. 11.

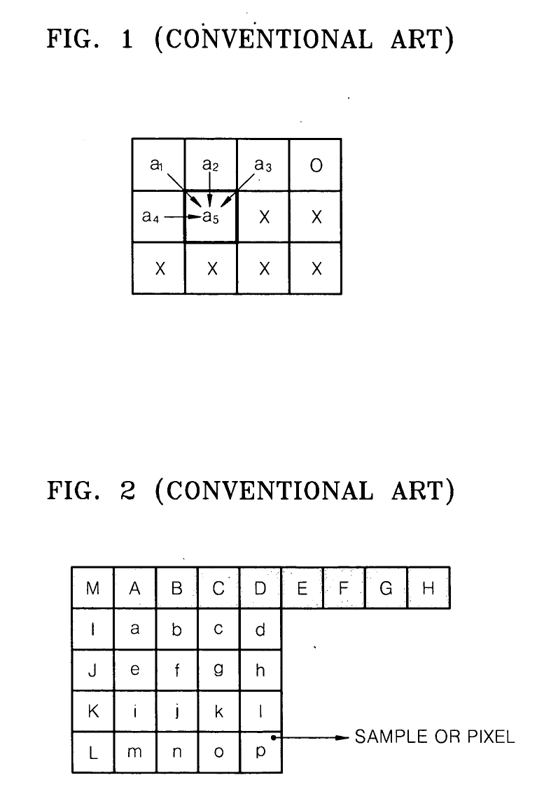

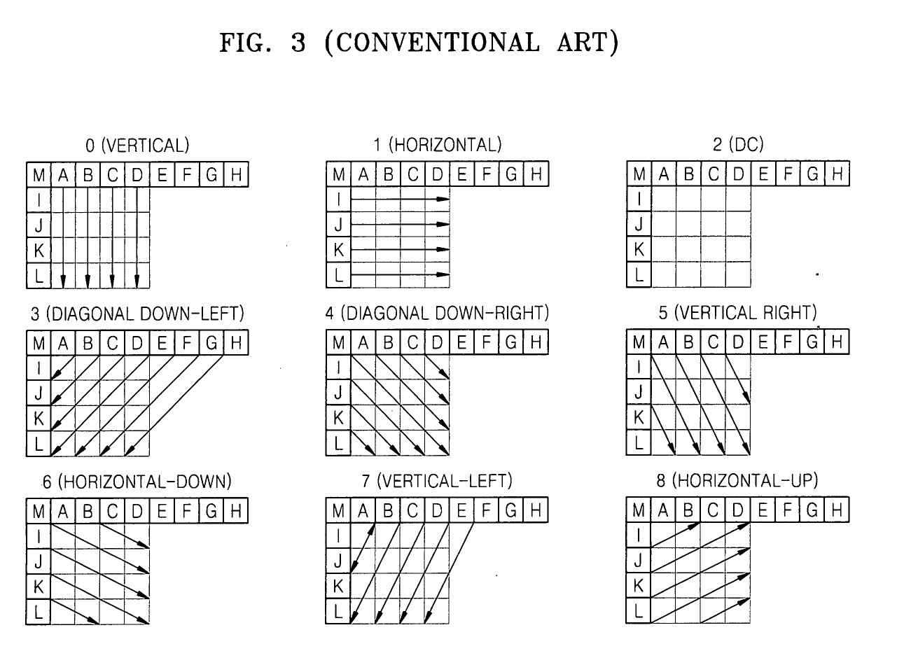

### DETAILED DESCRIPTION OF EXEMPLARY EMBODIMENTS OF THE PRESENT INVENTION

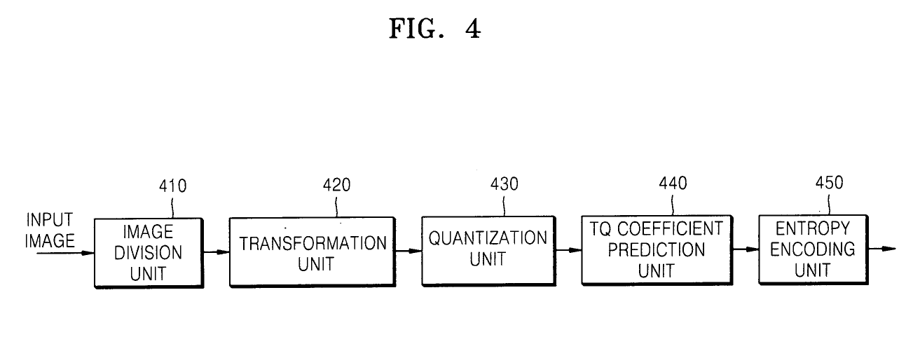

FIG. 4 is a block diagram of an image encoder according to an exemplary embodiment of the present invention.

Referring to FIG. 4, the image encoder includes an image division unit 410, a transformation unit 420, a quantization unit 430, a TQ coefficient prediction unit 440, and an entropy encoding unit 450. The TQ coefficient prediction unit 440 includes an intraprediction unit and an interprediction unit (not shown).

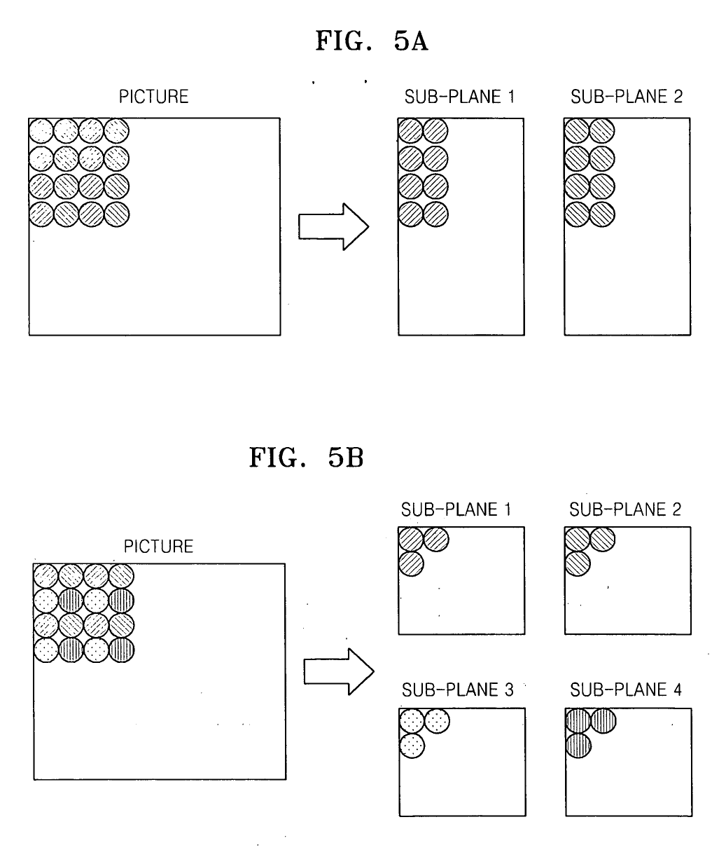

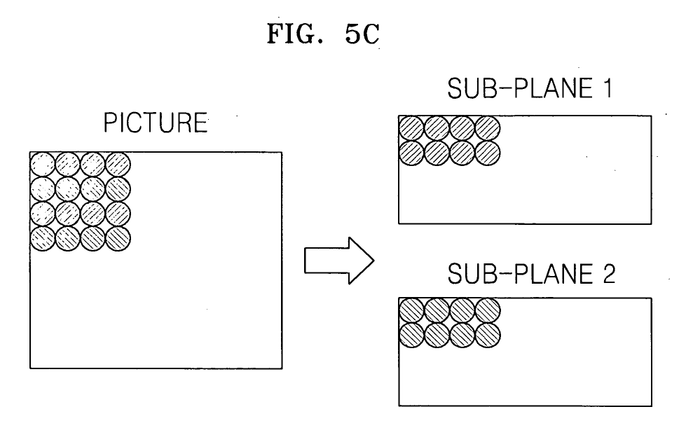

Hereinafter, an image encoding method according to an exemplary embodiment of the present invention will be described with reference to FIGS. 5 through 8.

The image division unit 410 sub-samples an input image of a certain size, e.g., a picture, and divides the picture into a number of sub-planes. The input image size and number of sub-planes both may be predetermined. For example, when the input image is in a common intermediate format (CIF), it may be divided into two 176×288 sub-planes as illustrated in FIG. 5A, four 176×144 sub-planes as illustrated in FIG. 5B, or two 352×144 sub-planes as illustrated in FIG. 5C. A picture is sub-sampled and then divided into a plurality of sub-planes, but the present inventive concept is not limited thereto, and a block of arbitrary size can be divided.

FIGS. 5A through 5C are views for explaining types of sub-planes into which a picture may be divided according to an exemplary embodiment of the present invention. In FIG. 5A, an input image is horizontally sub-sampled to obtain two sub-planes. In FIG. 5B, an input image is sub-sampled to obtain four sub-planes. In FIG. 5C, an input image is vertically sub-sampled to obtain two sub-planes.

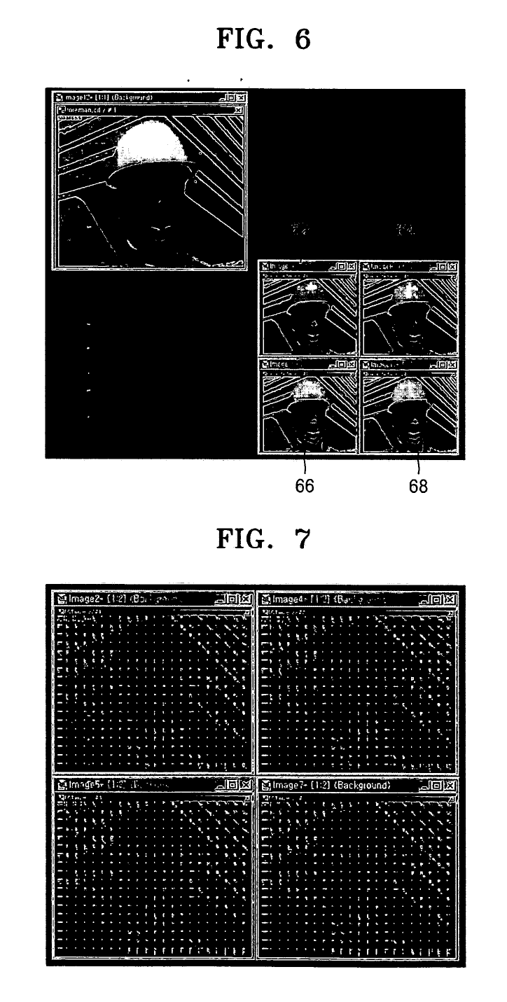

FIG. 6 illustrates four sub-planes 62, 64, 66, and 68 divided from a picture according to an exemplary embodiment of the present invention. The four sub-planes of FIG. 6 can be obtained using the sub-plane division method shown in FIG. 5B.

FIG. 7 illustrates coefficients obtained through transformation and quantization of the four sub-planes 62, 64, 66, and 68 of FIG. 6.

Returning to FIG. 4, the transformation unit 420 and the quantization unit 430 perform transformation and quantization on each of the sub-planes divided from the picture by the image division unit 410. Transformation and quantization are performed on each 8×8 block of a macroblock of each sub-plane. Since the transformation unit 420 and the quantization unit 430 function in the same way as those in an MPEG-4 or H.264 encoder, a detailed description thereof will not be provided.

The intraprediction unit (not shown) of the TQ coefficient prediction unit 440 performs intraprediction on at least one of the sub-planes that are transformed and quantized, e.g., on a first sub-plane. AC/DC prediction, or other such prediction methods, used for intraprediction in an MPEG-4 encoder may be used. Intraprediction is performed on transformed and quantized coefficients (which will be referred to as TQ coefficients) of each 8×8 block of a macroblock of a quantized sub-plane.

The intraprediction unit determines a sub-plane to be intrapredicted based on a certain criterion, e.g., determines a sub-plane at a certain position as a sub-plane to be intrapredicted, or performs intraprediction on all sub-planes and determines a sub-plane having the smallest cost as a sub-plane for use in interprediction encoding of remaining subplanes. The certain criterion may be predetermined, and the certain position may be predetermined.

In other words, after intraprediction is performed on all sub-planes, a cost of each sub-plane is determined. Costs of the sub-planes are compared and a sub-plane having the smallest cost is determined as a sub-plane for intraprediction.

The cost can be calculated using various methods. For example, cost functions such as a sum of absolute difference (SAD) cost function, a sum of absolute transformed difference (SATD) cost function, a sum of square difference (SSD) cost function, a mean of absolute difference (MAD) cost function, a Lagrange cost function may be used, or other similar function known in the art may be used. An SAD is a sum of absolute values of prediction residues of blocks, e.g., 4×4 blocks. An SATD is a sum of absolute values of coefficients obtained by applying a Hadamard transform to prediction residues of 4×4 blocks. An SSD is a sum of squared prediction residues of 4×4 block prediction samples. An MAD is an average of absolute values of prediction residues of 4×4 block prediction samples. The Lagrange cost function is a modified cost function using bitstream length information.

Although intraprediction encoding is performed on one of the plurality of sub-planes in an exemplary embodiment of the present invention, more than one sub-plane may be intraprediction encoded. For example, at least one sub-plane, e.g., two sub-planes, among four sub-planes may first be intraprediction encoded, and the other two sub-planes may be interprediction encoded thereafter to improve compression efficiency.

Next, the interprediction unit (not shown) of the TQ coefficient prediction unit 440 performs interprediction on the sub-planes that are not intrapredicted. In an exemplary embodiment of the present invention, interprediction is performed using the intrapredicted first sub-plane as a reference sub-plane. Interprediction may be performed using a previously interpredicted sub-plane as a reference sub-plane in addition to the intrapredicted first sub-plane.

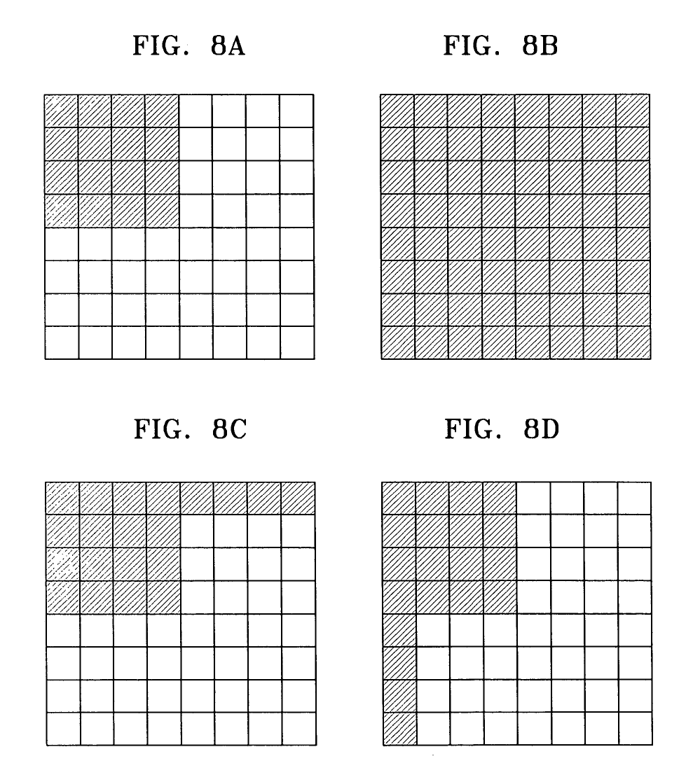

Interprediction is performed by obtaining a difference between TQ coefficients of a block of a sub-plane to be interpredicted and TQ coefficients of a corresponding block of a reference sub-plane, i.e., TQ coefficients of a reference block. The block may be predetermined. When interprediction is performed in units of 8×8 blocks, interprediction methods shown in FIGS. 8A through 8D may be used.

As such, in the image encoding method according to an exemplary embodiment of the present invention, an input image is sub-sampled in a spatial domain to generate a plurality of sub-planes and TQ coefficients of each of the sub-planes are intrapredicted or interpredicted in a frequency domain, thereby improving compression efficiency.

FIGS. 8A through 8D are views for explaining interprediction methods according to an exemplary embodiment of the present invention.

In FIG. 8A, only a 4×4 low-frequency component of a reference block is used for interprediction. In FIG. 8B, all of the frequency components of the reference block are used for interprediction. In FIGS. 8C and 8D, only a certain pattern of components of the reference block are used for interprediction. The certain pattern may be predetermined. Other patterns based on the spatial characteristics of an image may also be used in addition to the patterns illustrated in FIGS. 8C and 8D.

In the interprediction method of FIG. 8A, when there is a difference between nigh-frequency components due to image division or edges, interprediction with respect to a high-frequency component is not helpful for improving compression efficiency. Thus, interprediction is only performed on a low-frequency component. In such a case, interprediction is performed on a 4×4 low-frequency component of a current block to be interpredicted, i.e., a difference between the 4×4 low-frequency component of the current block and a corresponding 4×4 low-frequency component of a reference block is output, and the original coefficients are output for the remaining high-frequency components.

The interprediction methods of FIGS. 8C and 8D may be adaptively used according to the spatial characteristics of an image. The spatial characteristics of an input image may include the directivity of the input image, information about whether an edge is included in the input image, and the directivity of an edge.

During interprediction, one of the interprediction methods of FIGS. 8A through 8D may be used in units of macroblocks. Alternatively, one of the interprediction methods may be used in units of sequences or images according to the characteristics of the sequences or the spatial characteristics of the images.

The entropy encoding unit 450 performs entropy encoding on intrapredicted and interpredicted data obtained from the TQ coefficient prediction unit 440 and generates a bitstream to be transmitted.

For example, when an input image is a picture, upon completion of encoding with respect to all macroblocks of each sub-plane, data is arranged for each sub-plane and a header is inserted. In addition, sub-planes are arranged for each picture and a picture header is inserted. A bitstream may include data of N macroblocks.

Mode information including a size of a sub-plane, a number of sub-planes, a sub-plane type, a division method, information about intraprediction and interprediction, or other such mode information may be inserted into each picture or each macroblock.

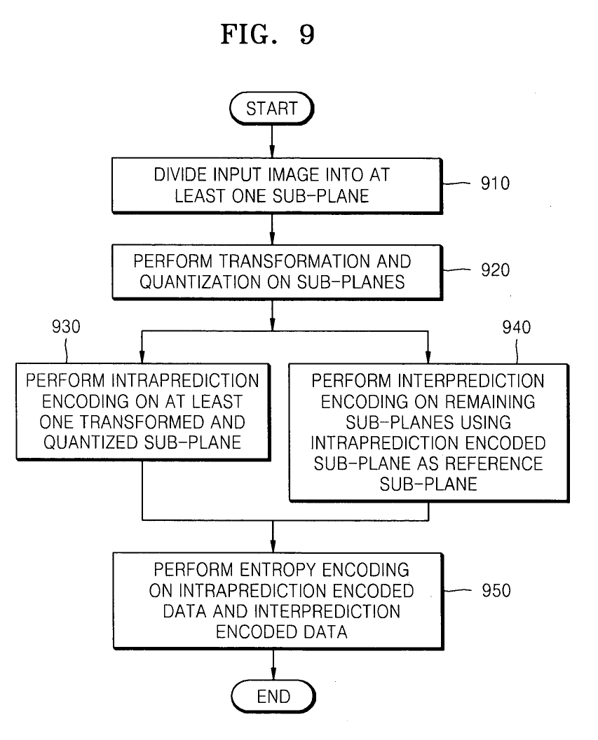

FIG. 9 is a flowchart illustrating an image encoding method implemented by the image encoder of FIG. 4.

An input image is divided into at least one sub-plane in operation 910.

Transformation and quantization are performed on the sub-planes in operation 920. In an exemplary embodiment of the present invention, transformation and quantization are performed on each 8×8 block of a macroblock of each sub-plane. Transformation and quantization may be performed on each macroblock or each block of a certain size, which may be predetermined.

Intraprediction is performed on at least one of the transformed and quantized sub-planes in operation 930. In an exemplary embodiment of the present invention, intraprediction is performed on TQ coefficients of each 8×8 block of a macroblock included in a quantized sub-plane. However, it is contemplated that intraprediction may also be performed on TQ coefficients of a subset of 8×8 blocks of a macroblock.

In operation 940, interprediction is performed on remaining transformed and quantized sub-planes using the intrapredicted sub-plane as a reference sub-plane. The interprediction involves obtaining a difference between coefficients of a current block and a reference block. In an exemplary embodiment of the present invention, interprediction is performed on each 8×8 block of a macroblock included in a quantized sub-plane. However, it is contemplated that interprediction may also be performed on TQ coefficients of a subset of 8×8 blocks of a macroblock. One of the patterns illustrated in FIGS. 8A through 8D may be used in interprediction.

Interprediction may be performed using a previously interpredicted sub-plane as a reference sub-plane, in addition to an intrapredicted sub-plane. In addition, interprediction may be performed on only a certain portion of a current block to be interpredicted, e.g., a low-frequency component, or a certain pattern of components. The certain portion and the certain pattern may both be predetermined. In other words, when a current block to be interpredicted is an 8×8 block, interprediction may be performed on only a 4×4 low-frequency component.

In operation 950, entropy encoding is performed on data intrapredicted in operation 930 and data interpredicted in operation 940 and an encoded bitstream to be transmitted is generated. The entropy encoding may be omitted.

While an intraprediction coded sub-plane is used as a reference sub-plane for interprediction, a previously interprediction coded sub-plane may also be used as the reference sub-plane.

In addition, mode information about sub-plane division and intraprediction and interprediction performed in operations 920 through 940 may be generated and the generated mode information may be inserted into the bitstream during the entropy encoding. The information about sub-plane division may be information about a sub-plane type, a division method, a size of sub-planes, a number of sub-planes, or other such information.

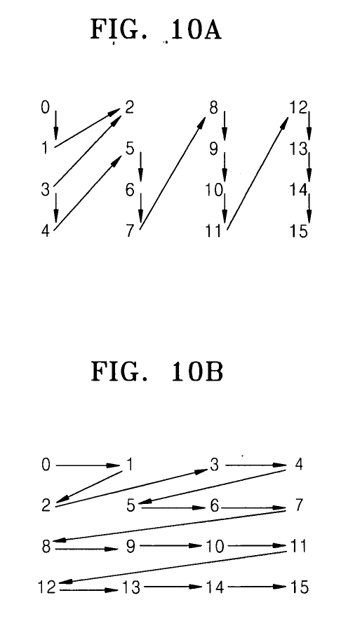

FIGS. 10A and 10B illustrate examples of a scan method applied to an exemplary embodiment of the present invention.

FIG. 10A illustrates a vertical sampling scan method and FIG. 10B illustrates a horizontal sampling scan method. In an exemplary embodiment of the present invention, an input image is divided into sub-planes of a certain type based on the characteristics of the input image and a scan method is selected to scan image data obtained by performing intraprediction on the sub-planes. The certain type may be predetermined, and the scan method may be predetermined. In other words, a scan method is adaptively used according to the type of sub-planes divided from the input image. When each picture of the input image is divided into sub-planes, information about a selected scan method may be inserted into each picture.

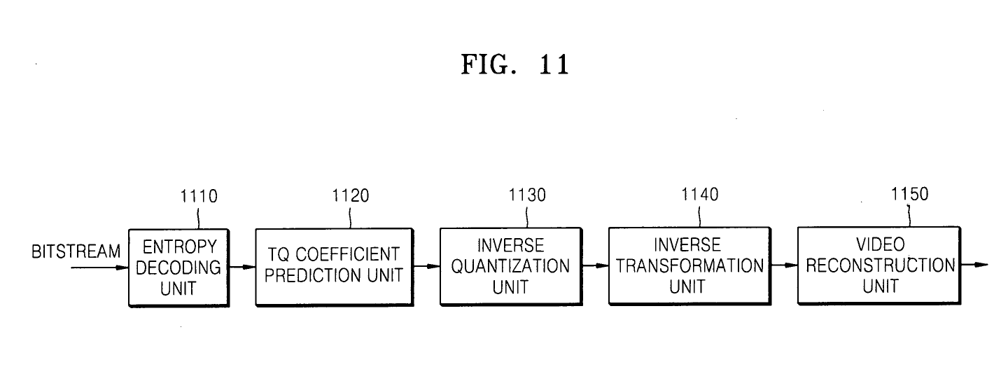

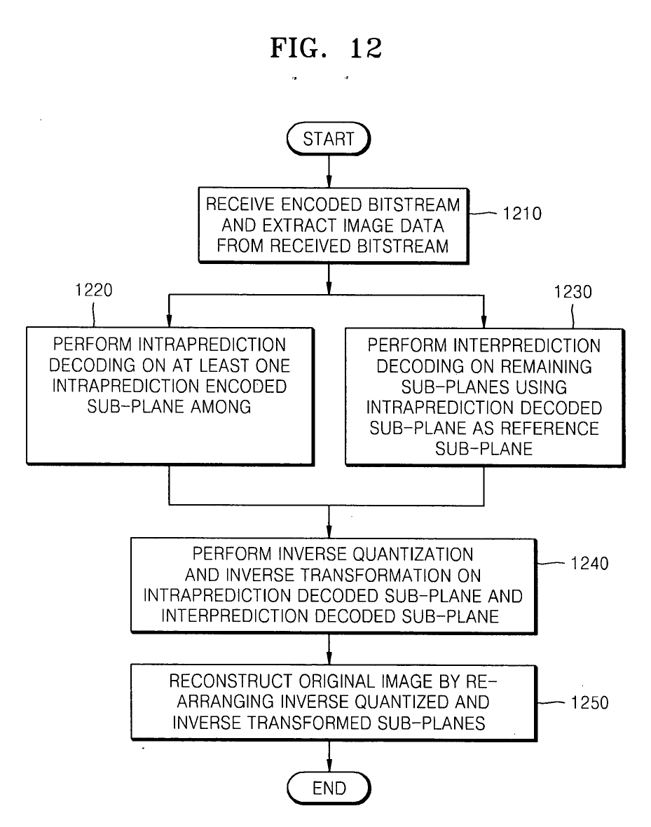

FIG. 11 is a block diagram of an image decoder according to an exemplary embodiment of the present invention.

Referring to FIG. 11, the image decoder includes an entropy decoding unit 1110, a TQ coefficient prediction unit 1120, an inverse quantization unit 1130, an inverse transformation unit 1140, and an image reconstruction unit 1150. The inverse quantization unit 1130 and the inverse transformation unit 1140 function in the same way as those in a conventional image decoder, e.g., a H.264 decoder, and a detailed description thereof will not be provided. The TQ coefficient prediction unit 1120 includes an intraprediction unit and an interprediction unit (not shown). The image decoder may further include a sub-plane reconstruction unit (not shown).

The entropy decoding unit 1110 receives an encoded bitstream, performs entropy decoding on the received bitstream to extract image data, and transmits the extracted image data to the TQ coefficient prediction unit 1120. The entropy decoding unit 1110 may also extract mode information from the received bitstream and transmit the extracted mode information to the TQ coefficient prediction unit 1120. The mode information regards sub-plane division, intraprediction, and interprediction, and may be inserted into a bitstream during entropy encoding. Information about sub-plane division is information about a sub-plane type, a division method, a size of sub-planes, a number of sub-planes, or other such information. The mode information may also include information about a scanning method.

The received bitstream includes image data obtained by performing transformation and quantization on a plurality of sub-planes divided from an input image, performing intraprediction encoding on at least one of the sub-planes, and performing interprediction encoding on at least one of the remaining sub-planes based on the intraprediction encoded sub-plane.

The intraprediction unit (not shown) of the TQ coefficient prediction unit 1120 performs intraprediction decoding on at least one intraprediction encoded sub-plane among the sub-planes included in the extracted image data. The TQ coefficient prediction unit 1120 may reconstruct sub-planes based on the mode information extracted from the received bitstream, in which case the intraprediction unit performs intraprediction decoding on at least one of the reconstructed sub-planes based on the extracted mode information, In an exemplary embodiment of the present invention, intraprediction decoding is performed on TQ coefficients of each 8×8 block of a macroblock included in a sub-plane.

The interprediction unit (not shown) of the TQ coefficient prediction unit performs interprediction decoding by referring to the intraprediction decoded sub-plane. Interprediction decoding is performed on a block of a sub-plane using a corresponding block of the intraprediction decoded sub-plane as a reference block. The block may be predetermined. Interprediction decoding is performed by adding coefficients of the reference block and coefficients of the block. In an exemplary embodiment of the present invention, interprediction is performed on each 8×8 block of a macroblock included in a sub-plane. Interprediction decoding may be performed using a previous interprediction decoded sub-plane as a reference sub-plane.

Interprediction decoding may be adaptively performed according to the mode information extracted from the received bitstream, i.e., corresponding to the interprediction encoding illustrated in FIGS. 8A through 8D. In other words, interprediction decoding may be performed on only a portion of a current block of a certain size to be interprediction decoded, e.g., a 4×4 low-frequency component of an 8×8 block, the entire 8×8 block, or a pattern of components as illustrated in FIG. 8C or 8D. The certain size and the pattern may both be predetermined.

The inverse quantization unit 1130 and the inverse transformation unit 1140 perform inverse quantization and inverse transformation on each of intraprediction encoded and intraprediction decoded sub-planes. In the current embodiment of the present invention, inverse transformation and quantization are performed on each predetermined-size block of a macroblock included in each sub-plane, e.g., on each 8×8 block. The inverse quantization unit 1130 and the inverse transformation unit 1140 function in the same way as those in a conventional image decoder, e.g., an MPEG-4 or H.264 decoder, and a detailed description thereof will not be provided.

The image reconstruction unit 1150 reconstructs the original image by re-arranging the inverse quantized and inverse transformed sub-planes. In other words, the original input image is reconstructed from the four sub-planes illustrated in FIG. 6. To this end, information about a sub-plane division method included in the mode information extracted from the received bitstream may be used.

The mode information includes all the information used for decoding, but an index specifying a mode table including information about all modes shared by an image encoder and an image decoder may be solely transmitted.

FIG. 12 is a flowchart illustrating an image decoding method implemented by the image decoder of FIG. 11.

Referring to FIG. 12, in operation 1210, an encoded bitstream is received and is entropy-decoded to extract image data included in the bitstream. In an exemplary embodiment of the present invention, the encoded bitstream includes image data obtained by performing transformation and quantization on a plurality of sub-planes divided from an input image, performing intraprediction encoding on at least one of the sub-planes, and performing interprediction encoding on at least one of the remaining sub-planes based on the intraprediction encoded sub-plane. The sub-planes may be reconstructed from the extracted image data. When entropy encoding is not performed on the encoded bitstream, entropy decoding may be omitted.

The encoded bitstream further includes mode information for decoding and the mode information is extracted from the bitstream. The mode information includes information about sub-plane division and intraprediction and interprediction. The information about sub-plane division is information about a sub-plane type, a division method, a size of sub-planes, a number of sub-planes or other such information. The mode information may further include information about a scanning method.

In operation 1220, intraprediction decoding is performed on an intraprediction encoded sub-plane among the sub-planes included in the extracted image data. In an exemplary embodiment of the present invention, intraprediction is performed on TQ coefficients of each 8×8 block of a macroblock included in a sub-plane.

In operation 1230, interprediction decoding is performed on at least one of the remaining sub-planes by referring to the intraprediction decoded sub-plane. Interprediction decoding is performed on a block of a sub-plane using a corresponding block of the intraprediction decoded sub-plane as a reference block. The block may be predetermined. In an exemplary embodiment of the present invention, interprediction decoding is performed on each 8×8 block of a macroblock included in a sub-plane, and is performed by adding coefficients of the reference block and coefficients of the block. Interprediction decoding may be performed using a previously interprediction decoded sub-plane as a reference sub-plane.

In operation 1240, inverse quantization and inverse transformation are performed on the decoded sub-planes. In an exemplary embodiment of the present invention, inverse quantization and inverse transformation are performed on each size block of a macroblock included in a sub-plane, e.g., each 8×8 block. The size of the block may be predetermined.

In operation 1250, the original image, e.g., a picture, is reconstructed by re-arranging the inverse quantized and inverse transformed sub-planes.

As described above, according to exemplary embodiments of the present invention, an image to be intraprediction encoded is divided into a plurality of sub-planes having similar characteristics and prediction is performed between TQ coefficients obtained by performing transformation and quantization on the sub-planes, thereby improving image compression efficiency.

In addition, interprediction is performed by adaptively selecting one of a plurality of interprediction encoding methods according to the spatial characteristics of an input image, thereby improving image compression efficiency.

Moreover, scanning for encoding and decoding is performed by adaptively selecting one of a plurality of scanning methods according to the spatial characteristic of an input image, thereby improving image compression efficiency.

It is noted that the present inventive concept can also be embodied as computer-readable code on a computer-readable recording medium. The computer-readable recording medium is any data storage device that can store data which can be thereafter read by a computer system. Examples of the computer-readable recording medium include read-only memory (ROM), random-access memory (RAM), CD-ROMs, magnetic tapes, floppy disks, optical data storage devices, and carrier waves (e.g., transmission over the Internet). The computer-readable recording medium can also be distributed over network coupled computer systems so that the computer-readable code is stored and executed in a distributed fashion.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An image encoding method comprising:
dividing an input image into at least two sub-planes;
performing transformation and quantization on the divided at least two sub-planes;
performing intraprediction encoding on at least one of the transformed and quantized sub-planes; and
performing interprediction encoding on at least one remaining transformed and quantized sub-plane that has not been intraprediction encoded by using the at least one intraprediction encoded sub-plane as a reference sub-plane.

2. The image encoding method of claim 1, wherein the interprediction encoding is performed on a block of the at least one the remaining transformed and quantized sub-plane which has not been intraprediction encoded using a corresponding block of the at least one intraprediction encoded sub-plane as a reference block.

3. The image encoding method of claim 2, wherein the interprediction encoding is performed by obtaining a difference between the reference block and the block.

4. The image encoding method of claim 2, wherein the interprediction encoding is performed on only a pattern of components of the block.

5. The image encoding method of claim 2, wherein the interprediction encoding is performed on only a low-frequency component of the block.

6. The image encoding method of claim 2, wherein the block is an 8×8 block and the interprediction encoding is performed on only a 4×4 low-frequency component of the block.

7. The image encoding method of claim 2, further comprising determining spatial characteristics of the input image,
wherein the interprediction encoding is performed on the entire block or a portion of the block according to the determined spatial characteristics of the input image.

8. The image encoding method of claim 1, wherein the dividing of the input image comprises sub-sampling the input image.

9. The image encoding method of claim 1, further comprising generating mode information including at least one of a size of each sub-plane, a number of sub-planes, and information about prediction.

10. An image encoder comprising:
an image division unit which divides an input image into at least two sub-planes;
a transformation and quantization unit which performs transformation and quantization on the at least two sub-planes;
an intraprediction encoding unit which performs intraprediction encoding on at least one of the transformed and quantized sub-planes; and
an interprediction encoding unit which performs interprediction encoding on at least one remaining transformed and quantized sub-plane that has not been intraprediction encoded by using the at least one intraprediction encoded sub-plane as a reference sub-plane.

11. The image encoder of claim 10, wherein the interprediction encoding unit performs interprediction encoding on a block of the at least one remaining transformed and quantized sub-plane using a corresponding block of the at least one intraprediction encoded sub-plane as a reference block.

12. The image encoder of claim 11, wherein the interprediction encoding unit performs interprediction by obtaining a difference between the reference block and the block.

13. The image encoder of claim 11, wherein the interprediction encoding unit performs interprediction encoding on only a pattern of components of the block.

14. The image encoder of claim 11, wherein the interprediction encoding unit performs interprediction encoding on only a low-frequency component of the block.

15. An image decoding method comprising:
receiving an encoded bitstream;
entropy decoding the received bitstream;
performing intraprediction decoding on at least one intraprediction encoded sub-plane included in the entropy decoded image data;
performing interprediction decoding on at least one remaining sub-plane included in the entropy encoded image data using the at least one intraprediction decoded sub-plane as a reference sub-plane; and
performing inverse quantization and inverse transformation on the intraprediction decoded and interprediction decoded sub-planes.

16. The image decoding method of claim 15, further comprising reconstructing an input image by re-arranging the intraprediction decoded and interprediction decoded sub-planes.

17. The image decoding method of claim 15, wherein the interprediction decoding is performed on a block of the at least one remaining sub-plane using a corresponding block of the at least one intraprediction decoded sub-plane as a reference block.

18. The image decoding method of claim 17, wherein the interprediction decoding is performed by adding coefficients of the reference block and coefficients of the block.

19. The image decoding method of claim 17, wherein the interprediction decoding is performed on only a pattern of components of the block.

20. The image decoding method of claim 17, wherein the interprediction decoding is performed on only a low-frequency component of the block.

21. The image decoding method of claim 17, wherein the block is an 8×8 block and the interprediction decoding is performed on only a 4×4 low-frequency component of the block.

22. The image decoding method of claim 15, further comprising extracting mode information from the bitstream, wherein the mode information includes at least one of a size of each of the sub-planes, a number of sub-planes, information about intraprediction, and information about interprediction.

23. An image decoder comprising:
an entropy decoding unit which receives an encoded bitstream, and performs entropy decoding on the received bitstream;
an intraprediction decoding unit which performs intraprediction decoding on at least one intraprediction encoded sub-plane included in the entropy decoded image data;
an interprediction decoding unit which performs interprediction decoding on at least one remaining sub-plane included in the entropy decoded image data using the at least one intraprediction decoded sub-plane as a reference sub-plane; and
an inverse quantization and inverse transformation unit which performs inverse quantization and inverse transformation on the intraprediction decoded and interprediction decoded sub-planes.

24. The image decoder of claim 23, further comprising an image reconstruction unit which reconstructs the,input image by re-arranging the intraprediction decoded and interprediction decoded sub-planes.

25. The image decoder of claim 23, wherein the interprediction decoding unit performs interprediction decoding on a block of the at least one remaining sub-plane using a corresponding block of the at least one intraprediction decoded sub-plane as a reference block.

26. The image decoder of claim 25, wherein the interprediction decoding unit performs interprediction decoding by adding coefficients of the reference block and coefficients of the block.

27. The image decoder of claim 25, wherein the interprediction decoding unit performs interprediction decoding on only pattern components of the block.

28. The image decoder of claim 25, wherein the interprediction decoding unit performs interprediction decoding on only a low-frequency component of the block.

29. A computer-readable recording medium having recorded thereon a program for performing an image encoding method comprising:
dividing an input image into at least two sub-planes;
performing transformation and quantization on the divided at least two sub-planes;
performing intraprediction encoding on at least one of the transformed and quantized sub-planes; and
performing interprediction encoding on at least one remaining transformed and quantized sub-plane that has not been intraprediction encoded by using the at least one intraprediction encoded sub-plane as a reference sub-plane.

30. A computer-readable recording medium having recorded thereon a program for performing an image decoding method comprising:
receiving an encoded bitstream;
entropy decoding the received bitstream;
performing intraprediction decoding on at least one intraprediction encoded sub-plane included in the entropy decoded image data;
performing interprediction decoding on at least one remaining sub-plane included in the entropy decoded image data using the at least one intraprediction decoded sub-plane as a reference sub-plane; and
performing inverse quantization and inverse transformation on the intraprediction decoded and interprediction decoded sub-planes.
